(19) United States
(12) Patent Application Publication
(10) Pub. No.: US 2011/0263186 A1
(43) Pub. Date: Oct. 27, 2011

(54) Bench top vibrating sanding table

(76) Inventor: Marvin R. Sevedge, Reno, NV (US)

(21) Appl. No.: 12/584,677

(22) Filed: Apr. 26, 2010

(51) Int. Cl. B24B 41/06; B23P 19/04

(52) U.S. Cl. 451/411; 29/525.01

(57) ABSTRACT

A bench top vibrating table, in particular an oscillating sanding table, with is controlled by a variable controlled motor, running an off set cam. This sanding table has the working surface of which an installable abrasive sheet rests, whereby said abrasive sheet is installed using an adhesive method or loop and hook (Velcro), to the sanding table which is made easier to operate and handle because it leaves hands free to work with the project.

This Bench Top Vibrating Sanding Table would be used for sanding projects (i.e. wood, plastics, etc), from the rough state to the finished item. Being a bench top unit, its height could be positioned for the operator's best comfort to reduce fatigue and increase productivity.

The user would have both hands free to work with his project on the top of a large, nine inch (9″) by eleven inch (11″) sanding table, which would hold a full sheet of sanding paper. Having both hands free is a major improvement for the safety of the operator over a hand held palm sander or using a large belt sander. That would eliminate the chance of dropping the palm sander or having their hands hit a sanding belt. Being able to use both hands would increase control of the project being sanded; in addition to a larger working surface it would allow larger projects to be sanded safely and evenly.

They will be able to move their project on and off the sanding table with the aid of a work surface that surrounds the sanding table.

The motion of the sanding table is controlled by a variable speed controller to the motor, which turns an off-set cam. The higher the speed, the finer the sanding would be. The sandpaper would be attached to the sanding table by either the loop and hook (Velcro™) method, or by a use of a separate table on which the sandpaper would be attached by a spray adhesive. This separate table would then attach to the unit by means of the loop and hook (Velcro™) method to the sanding table. The user could use more than one of these separate tables with different grits of sandpaper. The convenience of changing the sandpaper would increase the actual sanding time on their projects.

This Bench Top Vibrating Sanding Table's convenience and safety sets it apart from all the sanding systems on the market today.

### BACKGROUND OF THE INVENTION

The present invention concerns a bench top-vibrating table.

An orbital system works with a sanding table on which abrasive sheet is attached, either with adhesive or a loop and hook (Velcro). The sanding table is 9″ by 11″, which is the size of a full sheet of abrasive sheet (sand paper). This allows full use of the sanding table, and allowing both hands to be free. Rubber table mounts support the sanding table, leaving it free to move on the x-y-axes.

### SUMMARY OF THE INVENTION

The bench top vibrating sanding table according to the present invention has the advantage of being particularly convenient, leaving both hands free to control project part being sanded. It will increase the safety factor, abrasive performance and overall efficiency of the operator using the bench top-vibrating table.

Due to the fact that both hands are free, there is better control of the project piece.

Due to the fact that both hands are free, will help eliminates the fatigue over holding a palm sander.

Due to the fact that both hands are free increases the safety factor.

Due to the fact the sanding table can accept the loop and hook (Velcro) method; changing abrasive sheets would be quick and easy.

Due to the fact the sanding table can accept the loop and hook (Velcro) method, an alternative method using a conversion plate which can be attached to accept standard abrasive sheet, (sand paper), with spray adhesive.

Due to the fact that a full size abrasive sheet is used, the work area is larger.

Due to the fact that a full size abrasive sheet is used, the project piece could be large.

Due to the fact that a full size abrasive sheet is used, time would be saved over smaller sanding surfaces.

Due to the fact that a full size abrasive sheet is used, changing the used abrasive sheet out for a new one would happen less often.

Due to the fact that a full size abrasive sheet is used, different grits of abrasive could be used at the same time by dividing the sanding table.

Due to the fact that the abrasive sheet can be changed quickly to different grits allows saving time.

Due to the fact of a variable speed control for the motor allows the best rate of abrasive for different project.

Due to the fact there is a work area around the sanding table, allows the work piece to be moved on and off the sanding plate easily.

Due to the fact there is a work area around the sanding table, it is easy to move the project on and off the sanding table safety.

### BRIEF DESCRIPTION OF THE DRAWINGS

Exemplary embodiment of the invention are described in greater detail in the subsequent description with reference to the associated drawings

FIG. 1 Shows the front and side view of the Bench Top Vibrating Sanding Table

FIG. 2 Shows the sanding table both top and bottom views and conversion plate.

FIG. 3 Shows the top sanding table support

FIG. 4 Shows the inside view of the sanding table support

FIG. 5 Shows the inner support of the Bench Top Vibrating Sanding Table.

FIG. 6 Shows the motor and associated parts.

FIG. 7 Shows the back view of the Bench Top Vibrating Sanding Table.

### DETAILED DESCRIPTION OF THE PREFERRED EMBODIMENTS

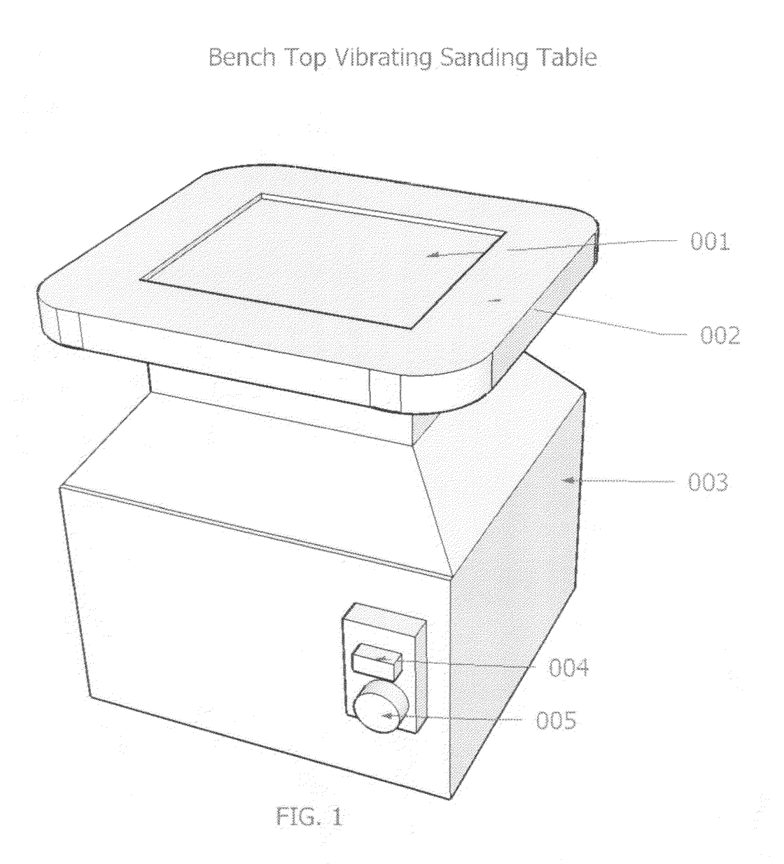

FIG. 1 shows a Bench Top Vibrating Sanding Table. The sanding table, (001), is positioned next to 002, work surface, that offers the convenience of moving the project on and off the sanding table easily and safety. Number 003, outside shell, supports the work surface and inter components. The 004, on and off switch, and 005, speed control, are conveniently located on the outside shell.

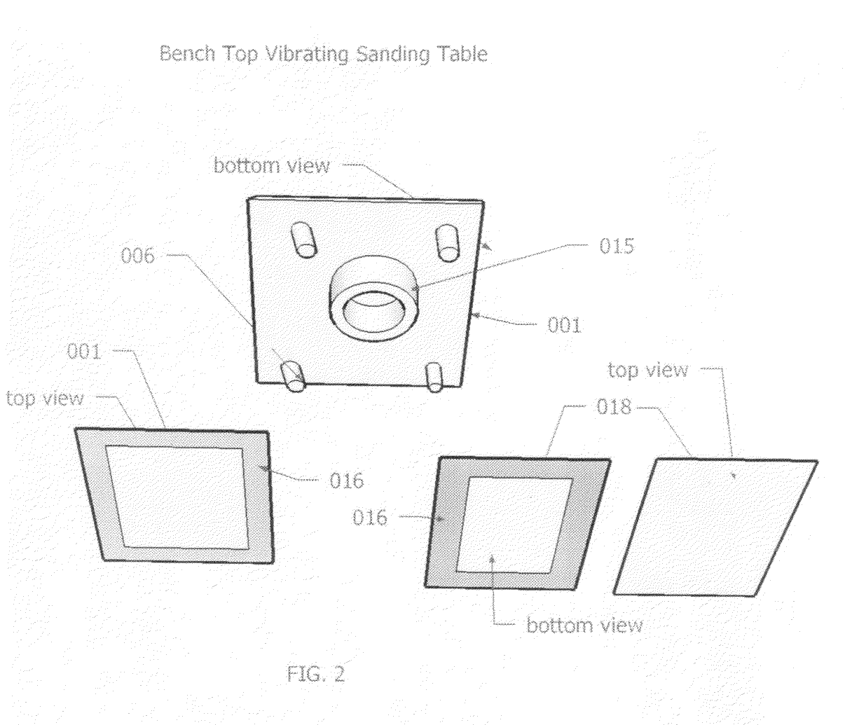

FIG. 2 shows the top and bottom view of the 001, sanding table. Located on the bottom of the 001, sanding table, are four (4) 006, upper table support guides. Number 015, the outer bearing housing, in which the 013, bearing rides. On the top view are 016, the hook of the loop and hook (Velcro), is located. Number 018, conversion plate, connects to 001, sanding table, by means of loop and hook (Velcro) method, to able the user to adhere standard sandpaper to 018, conversion plate, by means of a spray adhesives.

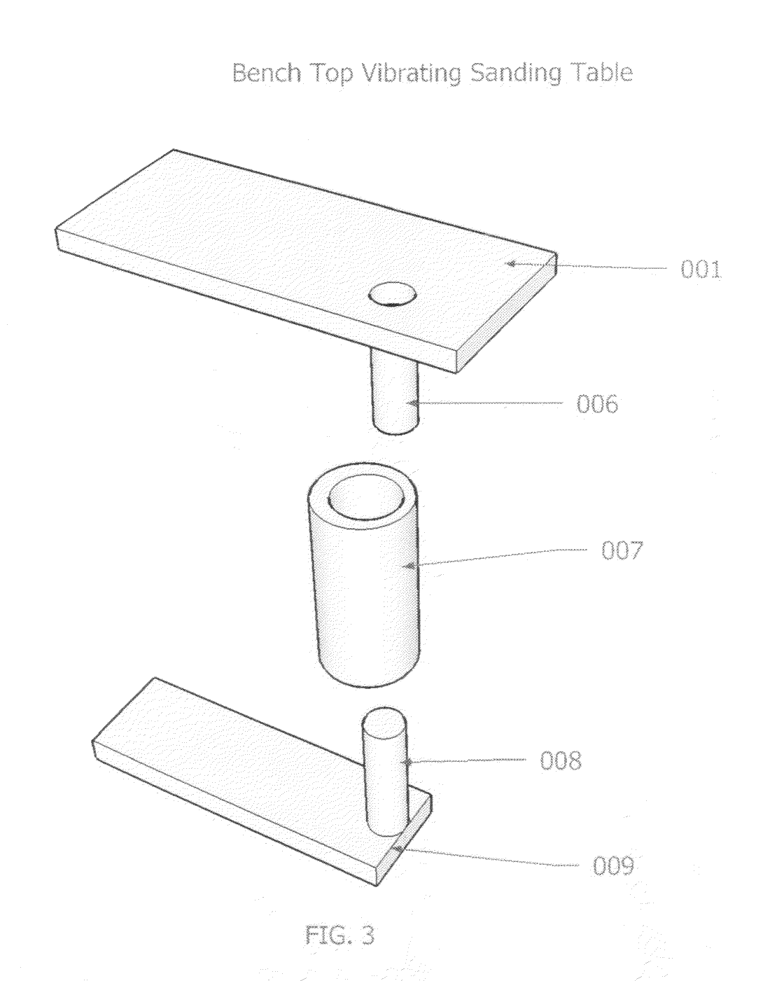

FIG. 3 shows how the sanding table is supported. On the sanding table, 001, four (4), 006, upper table support guides, are mounted to ride in 007, rubber mounts, which supports the weight of the sanding table and the project piece. There are four (4), 008, lower table support guides, that keeps the sanding table in place are mounted on two (2), 009, lower sanding table support.

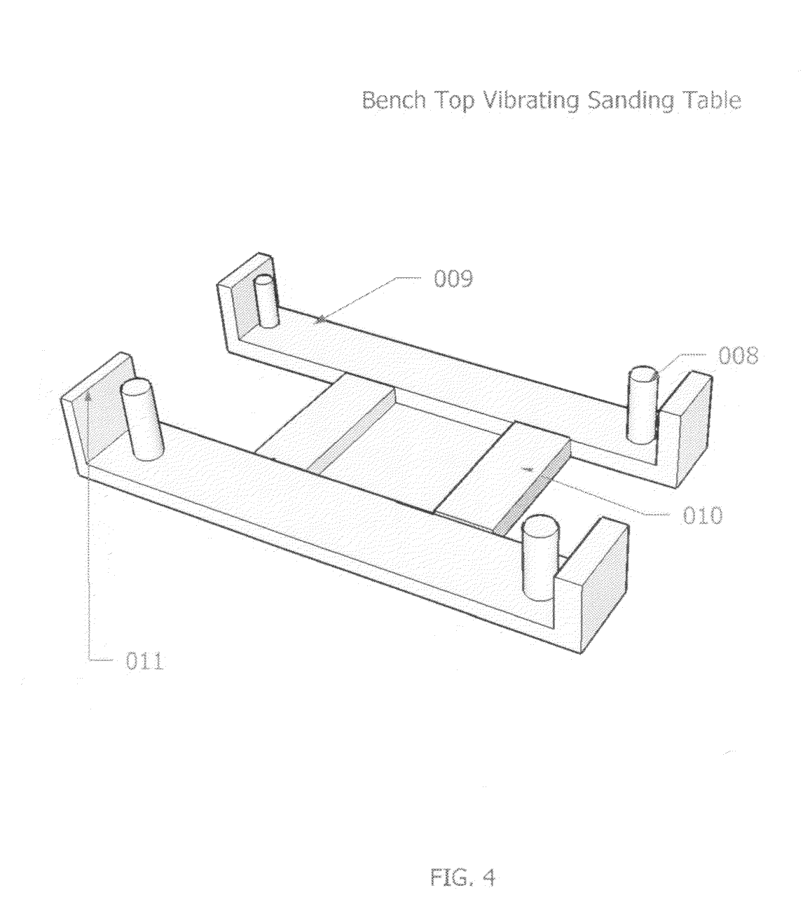

FIG. 4 shows the position on the four (4) 008, lower table support guides, that are placed on two (2), 009, table support bracket, which connect with four (4), 011 lower sanding table support tabs, to 003, outer shell. The two (2), 010, motor-mounting bars, are connected to the 009, lower sanding table support, to mount 014, an electrical motor.

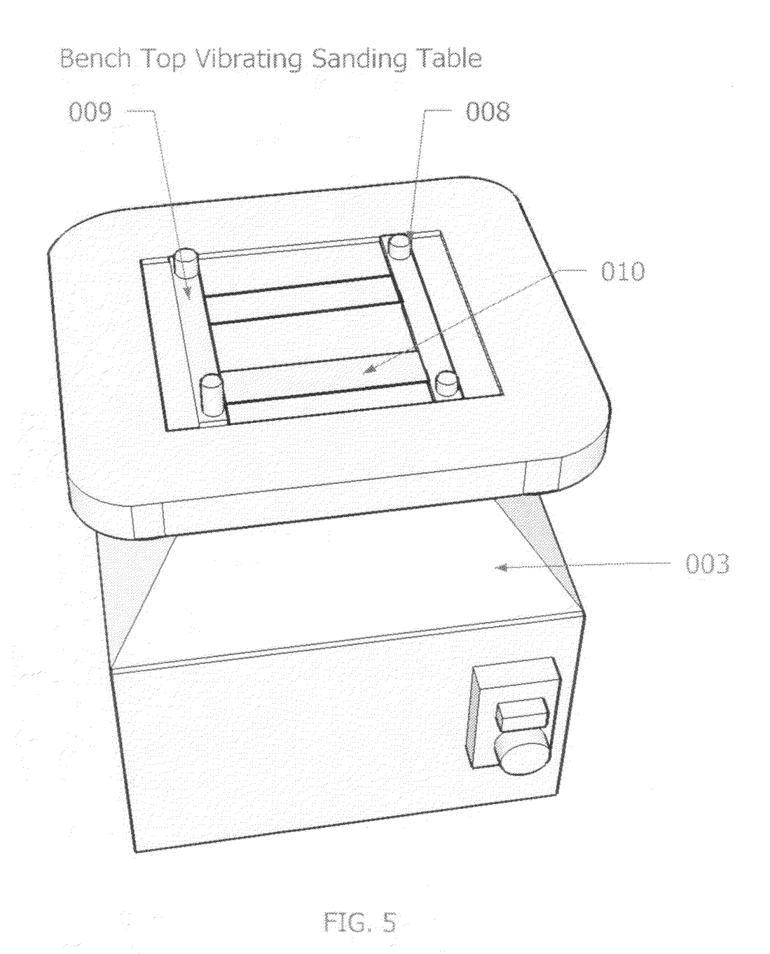

FIG. 5 shows the relationship of 008, lower sanding table support guides, 009, lower sanding table support and 010, motor mounting bars to 003, the outer shell.

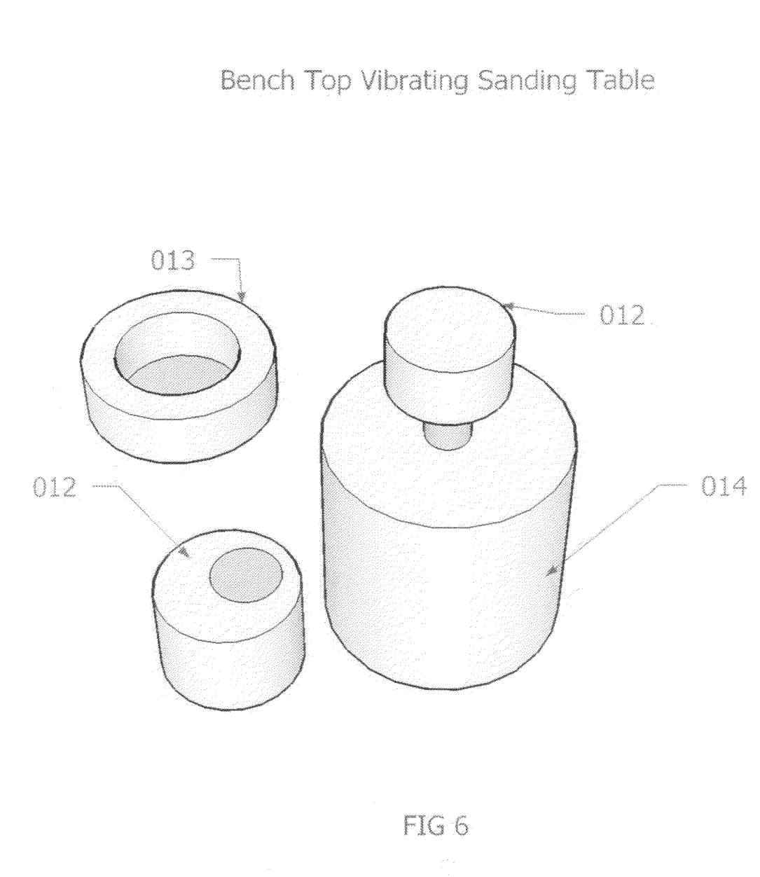

FIG. 6 shows 014, an electrical motor, with 012, an off set cam, giving the orbital motion to 001, sanding table, by means of 013, bearing, that rides in 015, the outer bearing housing, which is connected to the 001, sanding table.

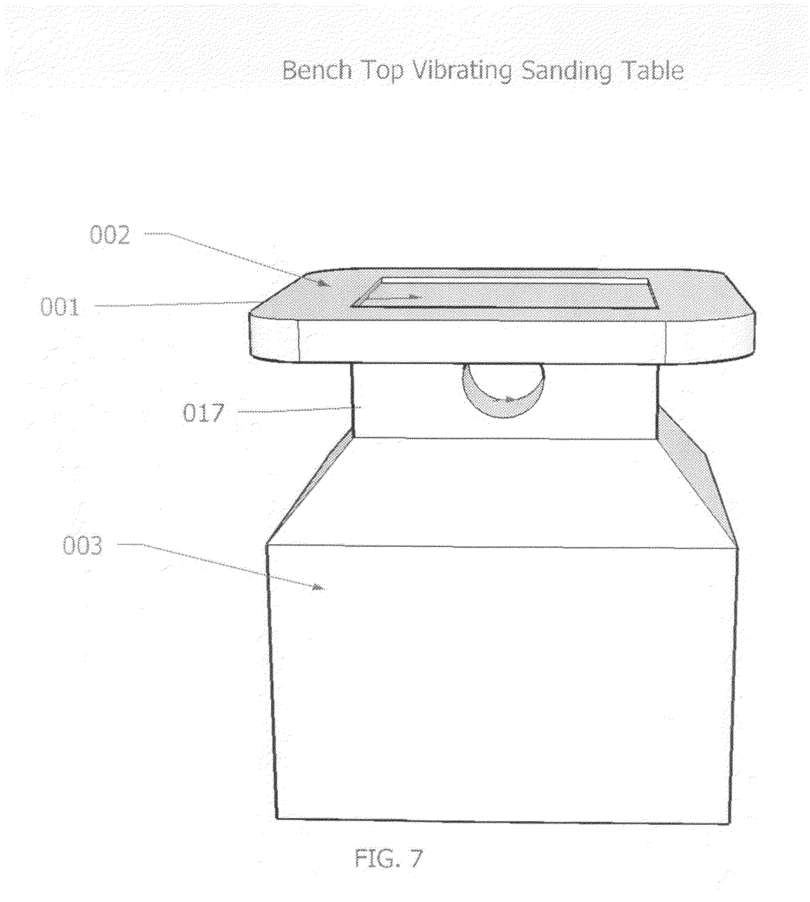

FIG. 7 Shows the back view of the Bench Top Vibrating Sanding Table, in which 017, dust vacuum port, is located on the outer shell for the removal of saw dust.

1. This Bench Top Vibrating Sanding Table would be used for sanding projects (i.e. wood, plastics, etc), from the rough state to the finished item.
Using different grits of sandpaper and different speeds the sander would sand the project from a rough stage to the finish stage with the same sanding table.

2. Being a bench top unit;
The height of the said sanding table could be positioned for the operator's best comfort to reduce fatigue and increase productivity.

3. The user would have both hands free to work with their project.
There is a large working table, nine inch (9″) by eleven inch (11″), which would hold a full sheet of sanding paper.
Having both hands free is a major improvement for the safety of the operator over a hand held palm sander or using a large belt sander.
Being able to use both hands would increase control of the project being sanded.

4. Different method of attaching sandpaper:
The sandpaper would be attached to the sanding table by either the loop and hook (Velcro™) method, or by a use of a separate plate on which the sandpaper would be attached by a spray adhesive.
This separate plate would then attach to the unit by means of the loop and hook (Velcro™) method to the sanding table.
The user could use more than one of these separate plates with different grits of sandpaper at the same time.
The convenience of changing the sandpaper would increase the actual sanding time on their projects.
